(19) United States
(12) Patent Application Publication
(10) Pub. No.: US 2007/0187870 A1
(43) Pub. Date: Aug. 16, 2007

(54) Multiple line embossing apparatus

(75) Inventors: Robert W. Lundstrom, Plymouth, MN (US); Peter E. Johnson, Maple Grove, MN (US)

Correspondence Address: HAMRE, SCHUMANN, MUELLER & LARSON, P.C., P.O. BOX 2902, MINNEAPOLIS, MN, 55402-0902, US

(73) Assignee: DATACARD CORPORATION, MINNETONKA, MN (US)

(21) Appl. No.: 11/346,141

(22) Filed: Feb. 2, 2006

(51) Int. Cl. B29C 49/00

(52) U.S. Cl. 264/284

(57) ABSTRACT

A multiple line embossing apparatus that is configured to emboss characters on a document, for example a card, on a line-by-line basis. The embossing apparatus uses guides that guide the card, and a tab belt that indexes the card along a card path. A second tab on the belt is provided to move the card in a reverse direction to start a new line of embossing. The guides and the tab belt move are able to move perpendicular to the card path to move the card to a new line of embossing.

### FIELD

The invention relates to an embossing apparatus, particularly a multiple line card embossing apparatus.

### BACKGROUND

Many identity and financial documents, for example cards, are provided with embossed characters. The embossed characters typically provide information on the intended holder of the card, for example the card holder's name or the card holder's account number, etc. The embossed characters are formed on the cards using an embosser.

In many cases, multiple lines of embossed characters are required on a card. In such cases, the embosser must be designed to accommodate the need for multiple line embossing. Many multiple line embossers use a card carriage that holds a card during embossing. The card is taken from an input, and transferred to the carriage which moves up and down, and side-to-side, together with the card during embossing. The card is then transferred from the carriage to be output. However, card carriages are prone to creating grip marks on the card, dropping the card during embossing, and allowing the card to slip resulting in uneven or “wavy” embossing. In addition, the process of getting a card into and out of a carriage is time consuming, which reduces card throughput through the embosser.

U.S. Pat. No. 3,820,455 discloses another known multiple line embosser, the DataCard Model 750, that uses a track that moves up and down with a card. The card is advanced in a forward direction only using a tab belt. In this embosser, characters in a vertical column are embossed, followed by advancement of the card to emboss the next vertical column of characters, and so on.

Embossing on a column-by-column basis tends to be slow. When the embosser is part of a central issuance, modular card processing system, which are designed to process thousands of cards per hour, any delay in the speed of embossing can cause a reduction in the throughput of the system.

### SUMMARY

An improved multiple line embossing apparatus is provided. The embossing apparatus is configured to emboss characters on a document, such as an identity document, including cards such as financial (e.g. credit and debit) cards, drivers' licenses, national identification cards, and other cards, and on passports. The embossing apparatus is configured to emboss on a line-by-line basis. When used to emboss cards, the embossing apparatus avoids many of the problems encountered with prior embossers, including avoiding the formation of grip marks on the card, dropped cards, and uneven or “wavy” embossing. Further, because the need to transfer the card to and from a card carriage is avoided, the throughput of the embossing apparatus is increased.

The embossing apparatus uses guides that guide the document, and a tab belt that indexes the document down a feed path. A second tab on the belt is provided to move the document in a reverse direction to start a new line of embossing. The guides and the tab belt are able to move perpendicular to a feed path to move the document to a new line of embossing.

Preferably, the embossing apparatus is a module for use in a central issuance, modular document processing system. However, the embossing apparatus could be used in other machines as well.

In one embodiment, an embossing apparatus for documents includes an input through which a document to be embossed is input to the embossing apparatus, an output through which the document exits the embossing apparatus, an emboss mechanism configured to emboss the document, and a document transport that transports the document within the embossing apparatus. The transport includes first and second document guides extending generally from adjacent the input to the emboss mechanism, with the first and second guides guiding first and second opposite edges of the document, a tab belt that extends generally from adjacent the input to the emboss mechanism, a reversible motor in driving engagement with the tab belt, a forward driving tab fixed to the belt that engages a third edge of a document for forward movements of the document, a reverse driving tab fixed to the belt that engages a fourth edge of a document for reverse movements of the document, and a drive mechanism connected to at least the first and second document guides that is configured to move the first and second document guides in a direction generally perpendicular to the forward and reverse directions of movement of the document.

In another embodiment, a document embossing process is provided. The process includes inputting a document to be embossed into an embosser through an input, transporting the document in a forward direction from the input to an emboss mechanism using a tab belt, and embossing a first line of characters onto the document using the emboss mechanism while the document is driven by the tab belt in the forward direction. After embossing the first line of characters, the document is driven in a reverse direction using the tab belt, and the document is moved in a direction generally perpendicular to the forward direction of movement of the document to position the document for embossing a second line of characters onto the document using the emboss mechanism. The second line of characters is then embossed onto the document.

### DRAWINGS

FIG. 1 is schematic depiction of a modular document processing system in which the embossing apparatus can be used.

FIG. 2 is a perspective view of the embossing apparatus.

FIG. 3 is a top view of the embossing apparatus.

FIG. 4 is a front view of the embossing apparatus taken along line 4-4 of FIG. 3.

FIG. 5 is a side view of the embossing apparatus that details how the document transport is moved up and down relative to the emboss mechanism.

FIG. 6 is a flow chart illustrating the embossing process.

### DETAILED DESCRIPTION

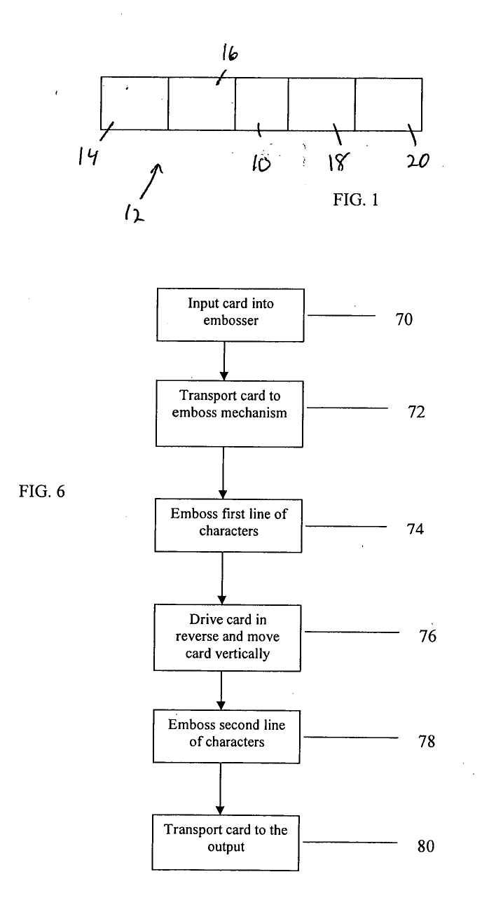

A multiple line embossing apparatus 10 is described with respect to illustrative FIGS. 1-6. The embossing apparatus 10 is configured to emboss characters on a document on a line-by-line basis. The document can be, for example, an identity document, such as a card including a financial (e.g. credit and debit) card, a drivers' license, a national identification card, and other cards. The identity document can also be a passport. Other documents can also be embossed using the embossing apparatus described herein.

For sake of convenience, the document will be described herein as being an identity card. The card can be made of plastic, a composite, or other materials suitable for forming an identity card.

The characters that are embossed are letters, numbers, symbols, and combinations thereof.

The words forward, reverse, upper, lower, rear, front, horizontal, vertical and the like are used herein with respect to the direction of movement of the card through the embossing apparatus and the orientation of the card as it is transported through the embossing apparatus.

Preferably, the embossing apparatus 10 is a module for use in a central issuance, modular card processing system 12 illustrated in FIG. 1. The inventive concepts will hereinafter be described with respect to the embossing apparatus being a module in the card processing system 12. However, the embossing apparatus could be used in other machines as well.

The system 12 includes a number of modules, each of which is configured to perform a particular operation on a card. For example, one module 14 can be an input module, one module 16 can be a print module, one module is the embossing module 10, one module 18 can be a color topper module, and one module 20 can be an output module.

The input module 14 typically holds a number of cards waiting to be processed, and feeds cards one at a time to the print module 16 which prints on a surface of each card. After printing, the cards are fed to the embossing module 10 for embossing of characters on to the cards, and then fed to the color topper module 18 which applies a color to the tops of the embossed characters. After topping, the cards are transported to the output module 20 where the finished cards are stacked.

The described system 12 is exemplary only. A number of other modules can be incorporated into the system 12 and the modules can be arranged in a number of sequences. In addition, the system 12 can be used with other systems, for example a mailer and inserter system. An example of a modular card processing system is described in U.S. Pat. No. 6,902,107.

With reference to FIGS. 2-5, the embossing apparatus 10 includes an input 22 through which a card to be embossed is input to the embossing apparatus, and an output 24 through which the embossed card exits the embossing apparatus. The input 22 and output 24 are aligned with the output and input of the modules 16, 18 upstream and downstream thereof, respectively. In other embodiments, such as in a non-modular environment, the input and the output could be the same whereby a card enters and exits the embosser through the same location, or the input and the output could be located on the same side of the embossing apparatus.

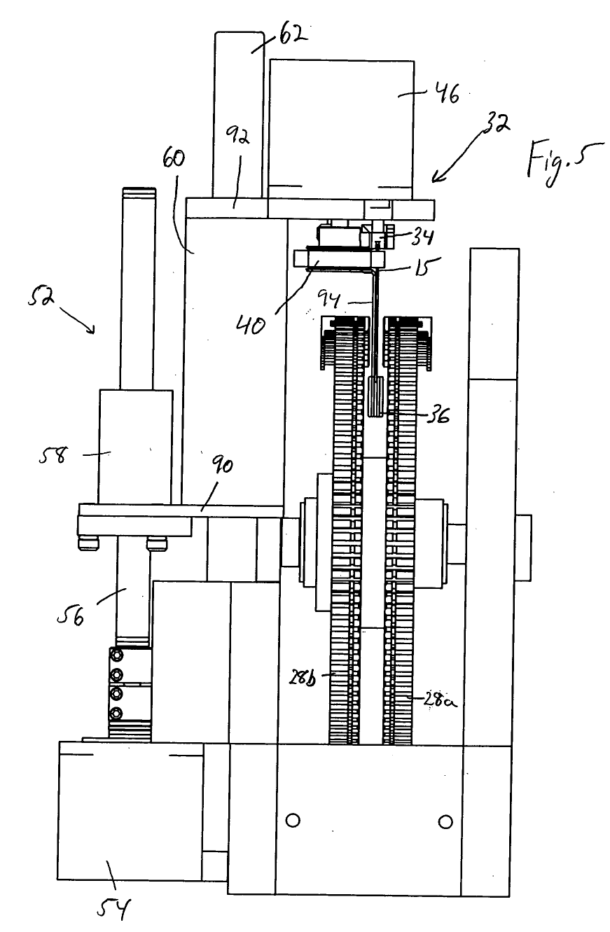

An emboss mechanism 26 that is configured to emboss the card is disposed between the input 22 and the output 24. The emboss mechanism 26 includes an emboss wheel 28 that is generally circular and contains a plurality of punches and dies for the characters to be embossed on the card. The emboss wheel 28 includes a first half 28a containing, for example, the dies, and a second half 28b that contains, for example, the corresponding punches. The two halves 28a, 28b are generally parallel to and face each other, and are positioned on opposite sides of a card path along which a card travels through the embossing apparatus 10 so that the cards travel generally between the two halves 28a, 28b (see FIG. 5). The punches and dies are actuated by actuators 30a, 30b, for example solenoids. The function and operation of the emboss mechanism 26 is well understood to a person of ordinary skill in the art. Further details of emboss mechanisms are disclosed in U.S. Pat. Nos. 5,070,781, 5,094,336 and 5,320,435.

A card transport 32 transports each card 15 both horizontally and vertically within the embossing apparatus 10. The card 15 is transported from adjacent the input 22 to the emboss mechanism 26 in a forward direction, and from the emboss mechanism 26 to the output 24 in the forward direction. The transport 32 picks up the card 15 that is output from the upstream module 16, transports it to and through the emboss mechanism 26, and thereafter transports the card to the output 24 for discharge to the next adjacent module 18. A pair of input rollers 33 are adjacent the input 22 to receive the card from the upstream module and drive the card into the emboss apparatus 10 a sufficient distance to be picked up by the card transport 32.

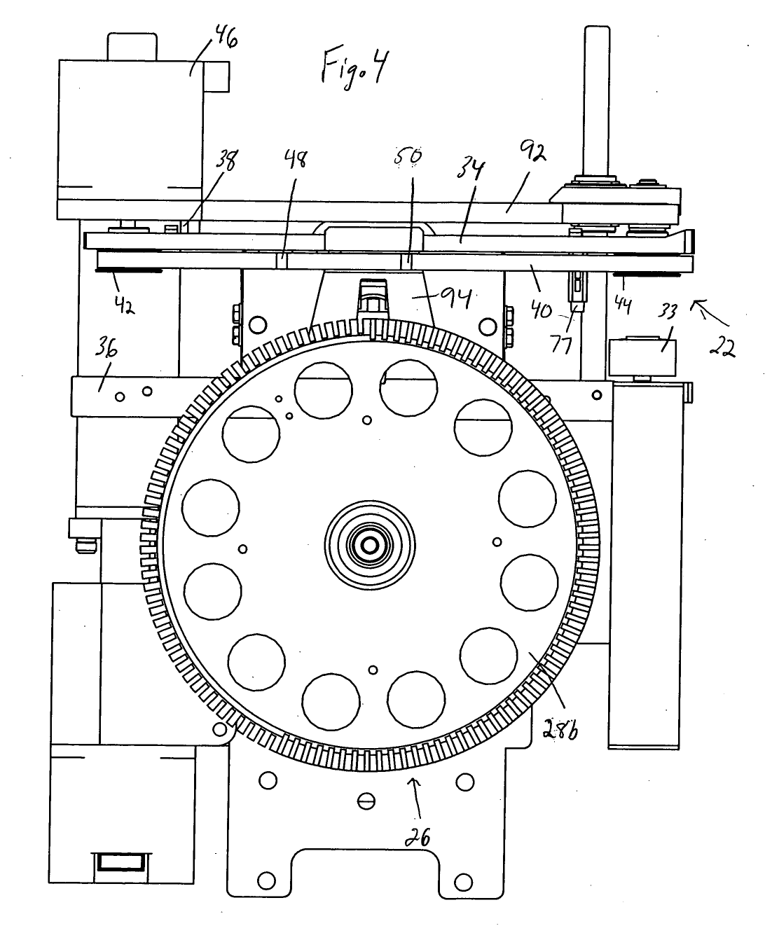

The card transport 32 includes first and second card guides 34, 36 each of which extends generally from adjacent the input 22, through the emboss mechanism 26, and to adjacent the output 24. In the illustrated embodiment, the card is transported through the embossing apparatus 10 in a vertical orientation (see FIG. 2), so that the first card guide 34 is an upper card guide that guides a first or upper edge of the card, while the second card guide 36 is a lower card guide that guides a second or lower edge of the card. The card guides 34, 36 define channels in which the upper and lower edges of the card slide as the card is transported through the embossing apparatus. The card guide 34 is spring loaded downward by a biasing member 38, for example a coil spring, to provide friction and prevent undesirable movements of the card (see FIG. 4).

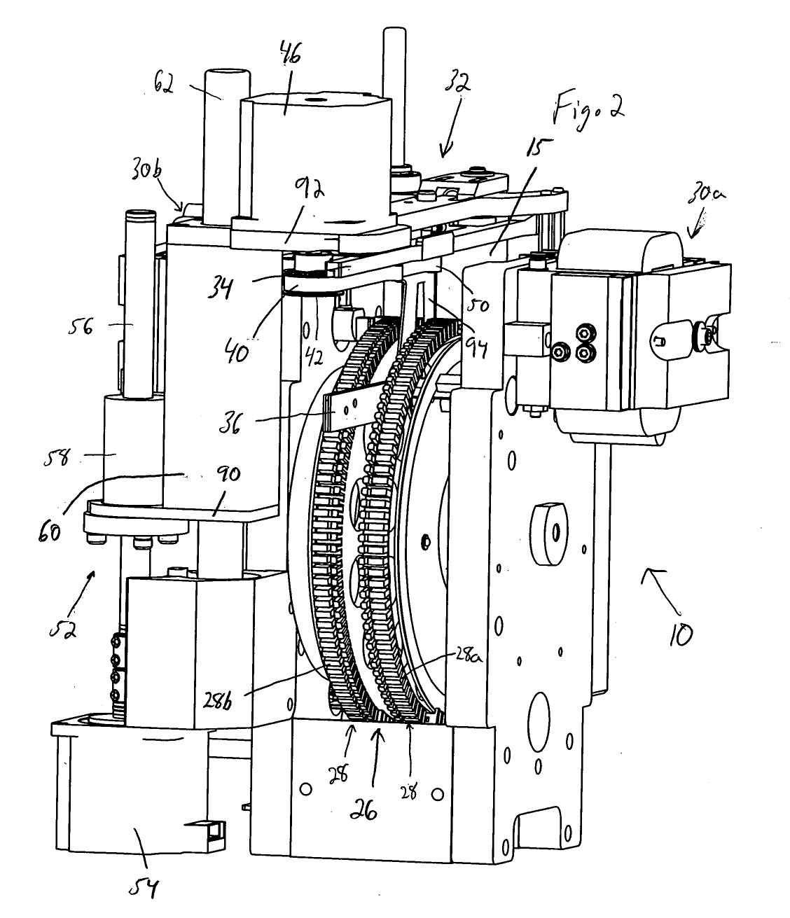

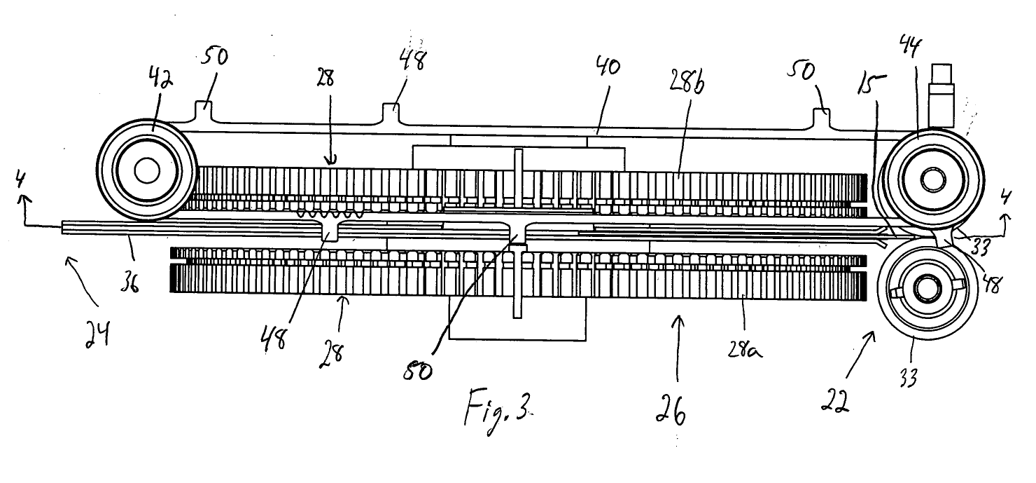

With reference to FIGS. 3 and 4, the card transport 32 also includes a tab belt 40 that extends generally from adjacent the input 22, through the emboss mechanism 26, and to adjacent the output 24. The tab belt 40 is an endless loop that extends around a pair of pulleys 42, 44 adjacent the input and output of the embossing apparatus 10. The pulley 42 is driven by a reversible stepper motor 46 while the pulley 44 is an idler pulley rotated by teeth provided on the tab belt 40. The reversible motor 46 is able to rotate the tab belt 40 in a forward direction for advancing the card 15 in a forward direction, and in a reverse direction for transporting the card in a reverse direction.

The tab belt 40 includes three pairs of tabs thereon, as shown in FIG. 3. Each tab pair includes a forward driving tab 48 fixed to the belt 40 that engages a third or rear edge of the card for forward movements of the card. In addition, each tab pair includes a reverse driving tab 50 fixed to the belt 40 that engages a fourth or front edge of the card for reverse movements of the card.

The card transport 32 further includes a drive mechanism 52 that is configured to move the card guides 34, 36, and thus the card 15, together with the tab belt 40 and the motor 46, in a direction generally perpendicular to the forward and reverse directions of movement of the card. As shown in FIGS. 2 and 5, the drive mechanism 52 includes a motor 54, for example a stepper motor, which is in driving engagement with a lead screw 56 for rotating the lead screw. A threaded nut 58 is disposed on the lead screw 56 and the nut 58 is connected to a set of bearings 60 that are slidably disposed on a shaft 62.

With reference to FIGS. 2 and 5, the nut 58 and bearing set 60 are fixed to a plate 90 that moves up and down relative to the lead screw 56 and shaft 62 along with the nut 58 and bearing set 60. In addition, a plate 92 is fixed to the upper end of the bearing set 60 and moved up and down relative to the shaft 62 with the bearing set 60. The stepper motor 46, pulleys 42, 44 and upper card guide 34 are each fixed to the plate 92 so as to move with the plate. In addition, a hanger 94 extends upwardly from the lower card guide 36 and connects to the upper card guide 34 to couple movements of the upper card guide to the lower card guide.

With this construction, the stepper motor 54 rotates the lead screw 56, thereby causing the nut 58 to move up or down relative to the lead screw 56. Since the nut 58 and bearing set 60 are fixed to the plate 90, the bearing set 60 also moves up or down with the nut 58. This causes the plate 92 at the upper end of the bearing set 60, along with the card guides 34, 36 and tab belt 40 connected thereto, to move up or down for adjusting the vertical position of the card 15 relative to the emboss mechanism 26 to perform a new line of embossing.

In an alternate construction, only the card guides 34, 36 are moved vertically while the tab belt 40 remains fixed. This alternative construction would shift the points where the tabs on the tab belt would engage the front and rear edges of the card 15. This alternative is viable as long as the vertical positions of the card guides 34, 36 would not interfere with the function of the tab belt.

With reference to FIG. 6, a process of embossing a card will now be described. Initially, at step 70, a card to be embossed is input into the embossing apparatus through the input 22. The card is picked up by the tab belt 40 as the forward driving tab 48 is rotated into position behind the rear edge of the card (see FIG. 3). At step 72, the card is transported by the tab belt 40 in a forward direction from the input 22 to the emboss mechanism 26.

Once the card is in position in the emboss mechanism, the emboss mechanism, at step 74, embosses a first line of characters onto the card while the card is driven by the tab belt in the forward direction. In the preferred embodiment, the tab belt indexes the card in the forward direction on a character by character basis, i.e. after the first character is embossed, the tab belt indexes the card one character space and embosses the second character, indexes the card another character space and embosses the third character, etc.

At step 76, after the first line of characters is embossed, the card is driven in a reverse direction using the tab belt, and the card is moved in a direction generally perpendicular to the forward direction of movement of the card to position the card for embossing a second line of characters (step 78) onto the card using the emboss mechanism. The reverse movement and vertical movement of the card can occur in either sequence or preferably simultaneously.

The card can be driven in the reverse direction to a home position prior to embossing the second line of characters onto the card, and during embossing of the second line the card is driven by the tab belt only in the forward direction for character by character embossing. In this embodiment, the return of the card to the home position functions similarly to a typewriter. As shown in FIG. 4, a sensor 77 is provided for sensing that the card has been returned to the home position, i.e. the position necessary for beginning the second line of embossing. Over time, one or more of the tabs on the tab belt 40 can break off the belt or break in such a manner that the reverse tab 50 fails to bring the card back to the home position. If the sensor 77 does not sense the card being returned, that can indicate a defect in the tab belt and the embossing can be halted to determine if a break has occurred.

Alternatively, the second line of embossing can occur as the card is being driven in the reverse direction. This alternative embodiment would be especially useful in the case where a third line of embossing is necessary, so that the first line of embossing occurs with the card moving forward, the second line occurs with the card moving in reverse, and the third line occurs with the card moving forward. In this case, the sensor 77 can determine whether the card has been correctly moved in the reverse direction during embossing. Alternatively, 2 or 3 of the multi-line embossers 10 can be provided in the card processing system 12, with each embosser embossing, for example, 2 lines or possibly only one line.

At step 80, after embossing is completed, the card is transported in the forward direction to the output 24 to output the embossed card to the next module 18.

1. An embossing apparatus for embossing documents, comprising:
an input through which a document to be embossed is input to the embossing apparatus;
an output through which the document exits the embossing apparatus;
an emboss mechanism configured to emboss the document; and
a document transport that transports the document within the embossing apparatus, the document transport including:
i) first and second document guides extending generally from adjacent the input to the emboss mechanism, the first and second document guides guiding first and second opposite edges of the document;
ii) a tab belt that extends generally from adjacent the input to the emboss mechanism;
iii) a reversible motor in driving engagement with the tab belt;
iv) a forward driving tab fixed to the belt that engages a third edge of the document for forward movements of the document;
v) a reverse driving tab fixed to the belt that engages a fourth edge of the document for reverse movements of the document;
vi) a drive mechanism connected to at least the first and second document guides that is configured to move the first and second document guides in a direction generally perpendicular to the forward and reverse directions of movement of the document.

2. The embossing apparatus of claim 1, wherein the drive mechanism is connected to the tab belt and the reversible motor and is configured to move the first and second document guides, the tab belt and the reversible motor in a direction generally perpendicular to the forward and reverse directions of movement of the document.

3. The embossing apparatus of claim 1, wherein the first and second document guides are upper and lower document guides, the first and second opposite edges are upper and lower edges of a document, and the document travels in a generally vertical orientation through the embossing apparatus.

4. The embossing apparatus of claim 1, wherein the output is spaced from the input with the emboss mechanism positioned between the input and the output.

5. The embossing apparatus of claim 4, wherein the document transport transports the document from the input to the output, the first and second document guides extend generally from adjacent the input to adjacent the output, and the tab belt extends generally from adjacent the input to adjacent the output.

6. The embossing apparatus of claim 1, wherein the apparatus is a module for use in a modular identity document processing system, the input is an input to the module and the output is an output from the module.

7. The embossing apparatus of claim 1, wherein the document is an identity document.

8. The embossing apparatus of claim 1, wherein the document is a card.

9. A document embossing process, comprising:
inputting a document to be embossed into an embossing apparatus through an input;
transporting the document in a forward direction from the input to an emboss mechanism using a tab belt;
embossing a first line of characters onto the document using the emboss mechanism while the document is driven by the tab belt in the forward direction;
after embossing the first line of characters, driving the document in a reverse direction using the tab belt, and moving the document in a direction generally perpendicular to the forward direction of movement of the document to position the document for embossing a second line of characters onto the document using the emboss mechanism; and
embossing a second line of characters onto the document.

10. The process of claim 9, further comprising transporting the document in the forward direction to an output using the tab belt and outputting the embossed document.

11. The process of claim 9, comprising driving the document in the reverse direction to a home position using the tab belt prior to embossing the second line of characters onto the document, whereby during embossing of the second line the document is driven by the tab belt in the forward direction.

12. The process of claim 9, wherein the document is an identity document.

13. The process of claim 9, wherein the document is a card.
